(19) United States
(12) Patent Application Publication
(10) Pub. No.: US 2020/0156288 A1
(43) Pub. Date: May 21, 2020

(54) METAMATERIAL AND MANUFACTURING METHOD THEREOF

(71) Applicant: Kuang-Chi Institute of Advanced Technology, Guangdong (CN)

(72) Inventors: Ruopeng Liu, Guangdong (CN); Zhiya Zhao, Guangdong (CN); Juehui Zhou, Guangdong (CN); Xin Tang, Guangdong (CN)

(21) Appl. No.: 16/626,620

(22) PCT Filed: Mar. 21, 2018
(86) PCT No.: PCT/CN2018/079814

§ 371 Date: Dec. 26, 2019

(30) Foreign Application Priority Data
Jun. 27, 2017 (CN) 201710499174.0

(51) Int. Cl. B29B 11/10; B29B 7/90; B29C 67/04; B28B 11/16; B28B 3/20; B28B 11/24; B29K 101/12; B29K 505/00

(52) U.S. Cl. CPC B29B 11/10; B29B 7/90; B29C 67/04; B28B 11/16; B29K 2505/00; B28B 11/243; B29K 2101/12; B29K 2995/0007; B28B 3/20

(57) ABSTRACT

The present disclosure provides a metamaterial manufacturing method. The manufacturing method includes the following steps: (a) separately adding insulating substrate powder and at least one of wave-absorbing agent powder and metal electrode powder to thermoplastic resin, and mixing them evenly to obtain a raw material; (b) applying a coextrusion process to the raw material according to a metamaterial microstructure design, to form a microstructure unit rodlike material; and (c) configuring the microstructure unit rodlike material in a cyclic microstructure configuration manner, placing the material in an extruder, and obtaining a cyclically configured metamaterial microstructure through coextrusion by using the extruder. The present disclosure further provides a metamaterial manufactured by using the foregoing method. The present disclosure provides a method for manufacturing a ceramic-substrate metamaterial that features high efficiency, low iteration costs, and a relatively high yield rate. A thinner and more efficient wave-absorbing metamaterial is obtained.

### TECHNICAL FIELD

The present disclosure relates to the electromagnetic communications field, and more specifically, to a metamaterial and a manufacturing method thereof.

### BACKGROUND

A metamaterial is an artificial composite structural material that has a supernormal physical property that a natural material does not have. In the metamaterial, artificial microstructures are cyclically arranged to change a dielectric constant and a magnetic permeability μ of each point in space, so that the whole metamaterial has a dielectric constant and a magnetic permeability μ that are superior to those of a common material within a specific frequency range. A refractive index n is equal to a square-root of a product of the dielectric constant and the magnetic permeability μ. That is, a metamaterial whose refractive index is superior to that of a common material can be manufactured.

Currently, a multi-component microstructure is usually manufactured through a microstructure overprinting process. With reference to a metal microstructure etching technology, a microstructure silk-screen printing technology, a counterpoint technology, and the like, component microstructures of a metamaterial are manufactured on a same substrate in an overlay manner. In this method, because components are manufactured in series, a procedure is complex, and error ratios are multiplied and superimposed, a final microstructure yield rate is low. The counterpoint technology in the overprinting technology is very crucial. However, it is difficult to ensure precision of the technology after a counterpoint operation is performed for a plurality of times. In addition, in the overprinting technology, a single template (for example, a silkscreen) needs to be manufactured for each component, thereby causing relatively high metamaterial iteration costs and a long period.

### SUMMARY

For prior-art disadvantages of a complex metamaterial preparation process and high costs, the present disclosure is intended to provide a new metamaterial manufacturing process of multi-component one-off molding and sintering.

According to an aspect of the present disclosure, a metamaterial manufacturing method is provided, including the following steps: (a) separately adding insulating substrate powder and at least one of wave-absorbing agent powder and metal electrode powder to thermoplastic resin, and mixing them evenly to obtain a raw material; (b) applying a coextrusion process to the raw material according to a metamaterial microstructure design, to form a microstructure unit rodlike material; and (c) configuring the microstructure unit rodlike material in a cyclic microstructure configuration manner, placing the material in an extruder, and obtaining a cyclically configured metamaterial microstructure through coextrusion by using the extruder.

In the manufacturing method, after step (c), the manufacturing method further includes the following step: (d) repeating step (c) to perform coextrusion for a plurality of times, until a design-required metamaterial microstructure size is obtained.

In the manufacturing method, after step (d), the manufacturing method further includes the following steps: (e1) obtaining, through cutting by using a wire cutting apparatus, metamaterial microstructure sheets in required thickness, and splicing the metamaterial microstructure sheets through mold pressing, isostatic pressing, bonding, or the like, to obtain an impedance matching metamaterial biscuit; and (f1) placing the impedance matching metamaterial biscuit in a sintering furnace for adhesive discharge and sintering, to complete manufacturing of a ceramic-substrate metamaterial.

In the manufacturing method, after step (d), the manufacturing method further includes the following steps: (e2) obtaining, through cutting by using a laser cutting apparatus, metamaterial microstructure sheets in required thickness, and laying the metamaterial microstructure sheets on a cambered mold through mold pressing, vacuum bag pressing, or the like, to form a cambered conformal metamaterial biscuit; and (f2) placing the corresponding cambered conformal metamaterial biscuit in a sintering furnace for adhesive discharge and sintering, to complete manufacturing of a cambered ceramic-substrate metamaterial tile.

In the manufacturing method, after step (d), the manufacturing method further includes the following step: (e3) obtaining, through cutting by using a wire cutting apparatus, metamaterial microstructure sheets in required thickness, to form an efficient metamaterial wave-absorbing part.

In the manufacturing method, the wave-absorbing agent powder includes one of or a combination of carbon fiber powder, silicon carbide fiber powder, or polycrystalline iron fiber powder.

In the manufacturing method, the metal electrode powder includes one of or a combination of titanium, vanadium, chromium, zirconium, niobium, molybdenum, hafnium, tantalum, or wolfram powder.

In the manufacturing method, the insulating substrate powder includes one of or a combination of polyimide, polyester, polyurethane, epoxy resin, or polymethyl methacrylate powder.

In the manufacturing method, the thermoplastic resin includes one of or a combination of polyethylene, polypropylene, polyvinyl chloride, polystyrene, polymethyl methacrylate, polyester, polyformaldehyde, polyamide, polyphenylether, vinylidene chloride, nikasol, polyvinyl alcohol, polyvinyl acetal, AS resin, ABS resin, acryl resin, fluororesin, nylon resin, polyacetal resin, or panlite.

In the manufacturing method, the manufacturing method includes: performing cyclic microstructure configuration on the microstructure unit rodlike material according to 4×4 or 5×5.

In the manufacturing method, a ratio of a mass sum of the wave-absorbing agent powder, the metal electrode powder, and the insulating substrate powder to mass of the thermoplastic resin is 0.1 to 0.5.

In the manufacturing method, the ratio of the mass sum of the wave-absorbing agent powder, the metal electrode powder, and the insulating substrate powder to the mass of the thermoplastic resin is 0.3 to 0.4.

In the manufacturing method, a ratio of a mass sum of the wave-absorbing agent powder and the metal electrode powder to the insulating substrate powder is 1:4 to 4:1.

According to another aspect of the present disclosure, a metamaterial manufactured according to the manufacturing method is further provided.

With development of metamaterial technologies, addition of a multi-component functional material provides broader space for metamaterial design. For example, materials with different impedance facilitate impedance matching of a metamaterial. A conjunction of a conventional wave-absorbing material and a wave-absorbing metamaterial can help obtain a lighter, thinner, and more efficient wave-absorbing metamaterial. The present disclosure overcomes process difficulties, such as a low yield rate and relatively low iteration efficiency, in a multi-component metamaterial manufacturing process are overcome, and provides a new ceramic metamaterial manufacturing process of multi-component one-off molding and sintering.

The present disclosure may be applied to processing and manufacturing of an impedance matching structure of a ceramic-substrate multi-impedance metamaterial, a wave-absorbing metamaterial, and an axially continuous metamaterial, and can provide related fields with a metamaterial manufacturing process that features convenient iteration, a short period, integrated molding, and a low yield rate.

The present disclosure provides a metamaterial manufacturing method that features high efficiency, low iteration costs, and a relatively high yield rate. Benefits are achieved through a coextrusion process.

### DETAILED DESCRIPTION OF THE DRAWINGS

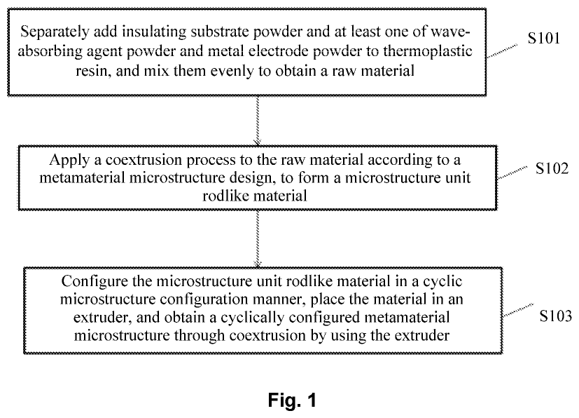

FIG. 1 is a flowchart of manufacturing a metamaterial according to some embodiments of the present disclosure; and

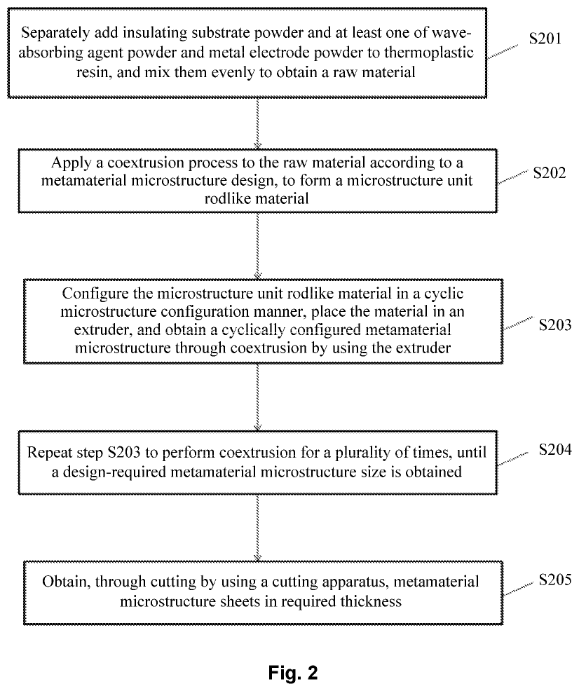

FIG. 2 is a flowchart of manufacturing a metamaterial according to some other embodiments of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure shall fall within the protection scope of the present disclosure.

A metamaterial manufacturing method provided in the present disclosure includes the following steps:

As shown in step S101 in FIG. 1 and step S201 in FIG. 2, separately add insulating substrate powder and at least one of wave-absorbing agent powder and metal electrode powder to thermoplastic resin, and mix them evenly to obtain a raw material. The wave-absorbing agent powder includes one of or a combination of carbon fiber powder, silicon carbide fiber powder, or polycrystalline iron fiber powder. The metal electrode powder includes one of or a combination of titanium, vanadium, chromium, zirconium, niobium, molybdenum, hafnium, tantalum, or wolfram powder. The insulating substrate powder includes one of or a combination of polyimide, polyester, polyurethane, epoxy resin, or polymethyl methacrylate powder. The thermoplastic resin includes one of or a combination of polyethylene, polypropylene, polyvinyl chloride, polystyrene, polymethyl methacrylate, polyester, polyformaldehyde, polyamide, polyphenylether, vinylidene chloride, nikasol, polyvinyl alcohol, polyvinyl acetal, AS resin, ABS resin, acryl resin, fluororesin, nylon resin, polyacetal resin, or panlite. In this step, a ratio of a mass sum of the wave-absorbing agent powder, the metal electrode powder, and the insulating substrate powder to mass of the thermoplastic resin is 0.1 to 0.5, with 0.3 to 0.4 preferred, and a ratio of a mass sum of the wave-absorbing agent powder and the metal electrode powder to the insulating substrate powder is 1:4 to 4:1.

Next, as shown in step S102 in FIG. 1 and step S202 in FIG. 2, apply a coextrusion process to the raw material according to a metamaterial microstructure design, to form a microstructure unit rodlike material.

Next, as shown in step S103 in FIG. 1 and step S203 in FIG. 2, configure the microstructure unit rodlike material in a cyclic microstructure configuration manner, place the material in an extruder, and obtain a cyclically configured metamaterial microstructure through coextrusion by using the extruder.

Next, as shown in step S204 in FIG. 2, repeat step S203 to perform coextrusion for a plurality of times, until a design-required metamaterial microstructure size is obtained.

Next, a manufacturing process further includes step S205 in FIG. 2: Obtain, through cutting by using a wire cutting apparatus, metamaterial microstructure sheets in required thickness, and perform subsequent processing on the metamaterial microstructure sheets to manufacture an impedance matching metamaterial biscuit, a ceramic-substrate metamaterial, a cambered conformal metamaterial biscuit, a cambered ceramic-substrate metamaterial tile, an efficient wave-absorbing part, and the like.

### Embodiment 1: Manufacture a Resin-Substrate Impedance Matching Metamaterial

1. Separately add carbon fiber powder, wolfram powder, and epoxy resin powder to polyethylene resin, and mix them evenly to make them have similar rheological properties, to obtain a raw material, where a ratio of a mass sum of the carbon fiber powder, the wolfram powder, and the epoxy resin powder to mass of the polyethylene resin is 0.28, a ratio of a mass sum of the carbon fiber powder and the wolfram powder to the epoxy resin powder is 1:4, and a mass ratio of the carbon fiber powder to the wolfram powder is 1:3.

2. According to a metamaterial microstructure design, add the raw material to a mold, and apply a coextrusion process to form a microstructure unit rodlike material with a clear interface.

3. Place several (4×4, 5×5, or the like) microstructure unit rodlike materials in an extruder, where the materials are configured in a designed cyclic microstructure configuration manner. Obtain a cyclically configured metamaterial microstructure through coextrusion by using the extruder.

4. Repeat step 3 to perform coextrusion for a plurality of times, until a design-required metamaterial microstructure size is obtained.

5. Obtain, through cutting by using a wire cutting apparatus, metamaterial microstructure sheets in required thickness, and splice the metamaterial microstructure sheets through mold pressing, isostatic pressing, bonding, or the like, to obtain an impedance matching metamaterial sample.

A yield rate of the impedance matching metamaterial sample tested by using a plate reflectivity method is 87%.

### Embodiment 2: Manufacture a Cambered Resin-Substrate Impedance Matching Metamaterial

1. Separately add silicon carbide fiber powder, titanium powder, and polyimide powder to polymethyl methacrylate resin, and mix them evenly to make them have similar rheological properties, to obtain a raw material, where a ratio of a mass sum of the silicon carbide fiber powder, the titanium powder, and the polyimide powder to mass of the polymethyl methacrylate resin is 0.36, a ratio of a mass sum of the silicon carbide fiber powder and the titanium powder to the polyimide powder is 4:1, and a mass ratio of the silicon carbide fiber powder to the titanium powder is 1:4.

2. According to a metamaterial microstructure design, add the raw material to a mold, and apply a coextrusion process to form a microstructure unit rodlike material with a clear interface.

3. Place several (4×4, 5×5, or the like) microstructure unit rodlike materials in an extruder, where the materials are configured in a designed cyclic microstructure configuration manner. Obtain a cyclically configured metamaterial microstructure through coextrusion by using the extruder.

4. Repeat step 3 to perform coextrusion for a plurality of times, until a design-required metamaterial microstructure size is obtained.

5. Obtain, through cutting by using a laser cutting apparatus, metamaterial microstructure sheets in required thickness, and lay the sheets on a cambered mold through mold pressing, vacuum bag pressing, or the like, to form a cambered conformal resin-substrate metamaterial.

A yield rate of the resin-substrate metamaterial tested by using a near-field test method is 95%.

### Embodiment 3: Manufacture an Efficient Resin-Substrate Wave-Absorbing Metamaterial

1. Separately add polycrystalline iron fiber powder and polymethyl methacrylate powder to polyvinyl chloride resin, and mix them evenly to make them have similar rheological properties, to obtain a raw material, where a ratio of a mass sum of the polycrystalline iron fiber powder and the polymethyl methacrylate powder to the polyvinyl chloride resin is 0.33, and a mass ratio of the polycrystalline iron fiber powder to the polymethyl methacrylate powder is 1:1.

2. According to a metamaterial microstructure design, add the raw material to a mold, and apply a coextrusion process to form a microstructure unit rodlike material with a clear interface.

3. Place several (4×4, 5×5, or the like) microstructure unit rodlike materials in an extruder, where the materials are configured in a designed cyclic microstructure configuration manner. Obtain a cyclically configured metamaterial microstructure through coextrusion by using the extruder.

4. Repeat step 3 to perform coextrusion for a plurality of times, until a design-required metamaterial microstructure size is obtained.

5. Obtain, through cutting by using a wire cutting apparatus, metamaterial microstructure sheets in required thickness, to form an efficient metamaterial wave-absorbing part.

A yield rate of the efficient metamaterial wave-absorbing part tested by using a plate reflectivity method is 90%.

### Embodiment 4: Manufacture a Ceramic-Substrate Impedance Matching Metamaterial

1. Separately add zirconium powder and polymethyl methacrylate powder to polyvinyl chloride resin, and mix them evenly to make them have similar rheological properties, to obtain a raw material, where a ratio of a mass sum of the zirconium powder and the polymethyl methacrylate powder to the polyvinyl chloride resin is 0.31, and a mass ratio of the zirconium powder to the polymethyl methacrylate powder is 3:1.

2. According to a metamaterial microstructure design, add the raw material to a mold, and apply a coextrusion process to form a microstructure unit rodlike material with a clear interface.

3. Place several (4×4, 5×5, or the like) microstructure unit rodlike materials in an extruder, where the materials are configured in a designed cyclic microstructure configuration manner. Obtain a cyclically configured metamaterial microstructure through coextrusion by using the extruder.

4. Repeat step 3 to perform coextrusion for a plurality of times, until a design-required metamaterial microstructure size is obtained.

5. Obtain, through cutting by using a wire cutting apparatus, metamaterial microstructure sheets in required thickness, and splice the metamaterial microstructure sheets through mold pressing, isostatic pressing, bonding, or the like, to obtain an impedance matching metamaterial biscuit.

6. Place the biscuit in a sintering furnace to perform an adhesive discharge and sintering process, to complete manufacturing of a ceramic-substrate metamaterial.

A yield rate of the ceramic-substrate metamaterial tested by using a plate reflectivity method is 84%.

### Embodiment 5: Manufacture a Cambered Ceramic-Substrate Impedance Matching Metamaterial

1. Separately add silicon carbide fiber powder, tantalum powder, and epoxy resin powder to ABS resin, and mix them evenly to make them have similar rheological properties, to obtain a raw material, where a ratio of a mass sum of the silicon carbide fiber powder, the tantalum powder, and the epoxy resin powder to mass of the ABS resin is 0.39, a ratio of a mass sum of the silicon carbide fiber powder and the tantalum powder to the epoxy resin powder is 4:1, and a mass ratio of the silicon carbide fiber powder to the tantalum powder is 1:2.

2. According to a metamaterial microstructure design, add the raw material to a mold, and apply a coextrusion process to form a microstructure unit rodlike material with a clear interface.

3. Place several (4×4, 5×5, or the like) microstructure unit rodlike materials in an extruder, where the materials are configured in a designed cyclic microstructure configuration manner. Obtain a cyclically configured metamaterial microstructure through coextrusion by using the extruder.

4. Repeat step 3 to perform coextrusion for a plurality of times, until a design-required metamaterial microstructure size is obtained.

5. Obtain, through cutting by using a laser cutting apparatus, metamaterial microstructure sheets in required thickness, and lay the sheets on a cambered mold through mold pressing, vacuum bag pressing, or the like, to form a cambered conformal metamaterial biscuit.

6. Place the corresponding cambered biscuit in a sintering furnace for adhesive discharge and sintering, to complete manufacturing of a cambered ceramic-substrate metamaterial tile.

A yield rate of the cambered ceramic-substrate metamaterial tile tested by using a near-field reflectivity method is 90%.

In the present disclosure, a polymer coextrusion process is combined with a metamaterial technology, to provide a method for manufacturing a ceramic-substrate metamaterial that features high efficiency, low iteration costs, and a relatively high yield rate. A thinner and more efficient wave-absorbing metamaterial is obtained through a coextrusion-cofiring process. The present disclosure may be applied to processing and manufacturing of an impedance matching structure of a ceramic-substrate multi-impedance metamaterial, a wave-absorbing metamaterial, and an axially continuous metamaterial, and can provide related fields with a metamaterial manufacturing process that features convenient iteration, a short period, integrated molding, and a low yield rate.

The foregoing are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A metamaterial manufacturing method, the manufacturing method comprises the following steps:
(a) separately adding insulating substrate powder and at least one of wave-absorbing agent powder and metal electrode powder to thermoplastic resin, and mixing them evenly to obtain a raw material;
(b) applying a coextrusion process to the raw material according to a metamaterial microstructure design, to form a microstructure unit rodlike material; and
(c) configuring the microstructure unit rodlike material in a cyclic microstructure configuration manner, placing the material in an extruder, and obtaining a cyclically configured metamaterial microstructure through coextrusion by using the extruder.

2. The manufacturing method as claimed in claim 1, wherein after step (c), the manufacturing method further comprises the following step:
(d) repeating step (c) to perform coextrusion for a plurality of times, until a design-required metamaterial microstructure size is obtained.

3. The manufacturing method as claimed in claim 2, wherein after step (d), the manufacturing method further comprises the following steps:
(e1) obtaining, through cutting by using a wire cutting apparatus, metamaterial microstructure sheets in required thickness, and splicing the metamaterial microstructure sheets through mold pressing, isostatic pressing, bonding, or the like, to obtain an impedance matching metamaterial biscuit; and
(f1) placing the impedance matching metamaterial biscuit in a sintering furnace for adhesive discharge and sintering, to complete manufacturing of a ceramic-substrate metamaterial.

4. The manufacturing method as claimed in claim 2, wherein after step (d), the manufacturing method further comprises the following steps:
(e2) obtaining, through cutting by using a laser cutting apparatus, metamaterial microstructure sheets in required thickness, and laying the metamaterial microstructure sheets on a cambered mold through mold pressing, vacuum bag pressing, or the like, to form a cambered conformal metamaterial biscuit; and
(f2) placing the corresponding cambered conformal metamaterial biscuit in a sintering furnace for adhesive discharge and sintering, to complete manufacturing of a cambered ceramic-substrate metamaterial tile.

5. The manufacturing method as claimed in claim 2, wherein after step (d), the manufacturing method further comprises the following step:
(e3) obtaining, through cutting by using a wire cutting apparatus, metamaterial microstructure sheets in required thickness, to form an efficient metamaterial wave-absorbing part.

6. The manufacturing method as claimed in claim 1, wherein the wave-absorbing agent powder comprises one of or a combination of carbon fiber powder, silicon carbide fiber powder, or polycrystalline iron fiber powder.

7. The manufacturing method as claimed in claim 1, wherein the metal electrode powder comprises one of or a combination of titanium, vanadium, chromium, zirconium, niobium, molybdenum, hafnium, tantalum, or wolfram powder.

8. The manufacturing method as claimed in claim 1, wherein the insulating substrate powder comprises one of or a combination of polyimide, polyester, polyurethane, epoxy resin, or polymethyl methacrylate powder.

9. The manufacturing method as claimed in claim 1, wherein the thermoplastic resin comprises one of or a combination of polyethylene, polypropylene, polyvinyl chloride, polystyrene, polymethyl methacrylate, polyester, polyformaldehyde, polyamide, polyphenylether, vinylidene chloride, nikasol, polyvinyl alcohol, polyvinyl acetal, AS resin, ABS resin, acryl resin, fluororesin, nylon resin, polyacetal resin, or panlite.

10. The manufacturing method as claimed in claim 1, wherein the manufacturing method comprises: performing cyclic microstructure configuration on the microstructure unit rodlike material as claimed in 4×4 or 5×5.

11. The manufacturing method as claimed in claim 1, wherein a ratio of a mass sum of the wave-absorbing agent powder, the metal electrode powder, and the insulating substrate powder to mass of the thermoplastic resin is 0.1 to 0.5.

12. The manufacturing method as claimed in claim 11, wherein the ratio of the mass sum of the wave-absorbing agent powder, the metal electrode powder, and the insulating substrate powder to the mass of the thermoplastic resin is 0.3 to 0.4.

13. The manufacturing method as claimed in claim 1, wherein a ratio of a mass sum of the wave-absorbing agent powder and the metal electrode powder to the insulating substrate powder is 1:4 to 4:1.

14. A metamaterial manufactured as claimed in the manufacturing method as claimed in claim 1.
